(19) United States
(12) Patent Application Publication
(10) Pub. No.: US 2026/0168301 A1
(43) Pub. Date: Jun. 18, 2026

(54) PIVOT DOOR ANCHORING DEVICE

(71) Applicant: FRITSJURGENS HOLDING B.V., Kolham (NL)

(72) Inventors: Durk ROVERS, Kolham (NL); Martin Erwin MULDER, Kolham (NL)

(21) Appl. No.: 19/125,038

(22) PCT Filed: Oct. 31, 2023
(86) PCT No.: PCT/EP2023/080386

§ 371 Date: Apr. 28, 2025

(30) Foreign Application Priority Data
Oct. 31, 2022 (EP) 22204723.5

(51) Int. Cl. E05D 7/081

(52) U.S. Cl. CPC E05D 7/081

(57) ABSTRACT

A pivot door anchoring device for pivotally connecting a pivot hinge member for a pivot door with a structural element comprises an anchoring body, a slider body, a linear guide structure to guide the slider body linearly in a horizontal axial direction relative to the anchoring body, and a pivot pin angle adjustment assembly. The assembly has a pivot pin member rotatably about a pivot axis in the slider, a lever member connected to the pivot pin member, and a lever adjustment member such that operating the lever adjustment member causes the lever member and the pivot pin member to rotate about the pivot axis. The linear guide structure comprises two parallel elongated protrusions projecting upward on the anchoring body and two parallel elongated recesses in the slider body, the protrusions being confined in the recesses to allow for motion of the slider body linearly in the axial direction relative to the anchoring body and to prevent motion of the slider body relative to the anchoring body in a horizontal direction perpendicular to the axial direction.

### CROSS-REFERENCE TO RELATED APPLICATIONS

This application is the National Stage of International Application No. PCT/EP2023/080386, filed Oct. 31, 2023, which claims priority to EP 22204723.5, filed Oct. 31, 2022, all of which are entirely incorporated herein by reference.

### TECHNICAL FIELD

The invention relates to the field of pivot door anchoring devices for pivotally connecting a pivot hinge member for a pivot door with a structural element. For example, the pivot door anchoring device is configured to receive a pivot pin of a pivot hinge member that is mounted to a door, e.g. along a lower door edge.

### BACKGROUND

The pivot door anchoring device is typically mounted to the structural element, e.g. to a floor, a ceiling, or a door frame, using projecting anchor members, e.g. anchor fasteners, e.g. anchor bolts, e.g. to be embedded or otherwise secured to the floor.

In a commonly known embodiment, the pivot door anchoring device receives the pivot pin of a pivot hinge member that is mounted to a pivot door. Alternatively, the pivot door anchoring device comprises a pivot pin that is received in an opening in the pivot hinge member of the door.

The pivot door has an upper edge, a lower edge, an inner side edge, and an outer side edge, and the pivot pin defines a vertical pivot axis for the pivot door.

The pivot pin of a pivot hinge member for the pivot door and the pivot door anchoring device are, in practical and in known embodiments, configured such that the pivot door has at least one stable position, e.g. a closed position, relative to the structural element, and can be rotated around the vertical pivot axis in two directions relative to the stable position, e.g. corresponding to the closed position. In other words, the pivot door can then be rotated around the vertical pivot axis and as such can swing between the closed position and opened positions in two directions. This vertical pivot axis for the door is typically defined by a pivot pin at an upper end thereof and a pivot pin at a lower end thereof.

For a satisfactory installation of a pivot door some adjustment of an angular orientation and/or location of a pivot pin may be required, e.g. so as to align the two pivot pins and/or to align the pivot door with its surroundings, e.g. wall(s), door frame, etc.

A pivot door anchoring device is, for example, known from US2021025208, wherein an adjusting base for a door closer is disclosed. The adjusting base includes a fixing member configured to be fixed to a floor surface and an adjusting member configured to receive the pivot pin of a pivot hinge. The adjusting member is arranged on the fixing member in an adjustable manner. The fixing member is provided with two upwardly projecting square protrusions that each extend into a respective wider opening in the adjusting member. The adjusting member is provided with multiple adjusting fasteners per opening, which fasteners engage on the protrusion. In a loosened state of all adjusting fasteners the adjusting member is movable in a horizontal plane relative to the fixing member to set the angular orientation as well as the position of the adjusting member. In a fastened state of the adjusting fasteners the adjusting member is fixated relative to the fixing member. This known pivot door anchoring device is disadvantageous as, for example, adjusting the anchoring device is cumbersome.

A pivot door anchoring device is known from CN104653009B, in particular the embodiment as disclosed in relation to FIG. 6a, b, and c thereof. Herein, the slider body is located within a central space within the anchoring body. The slider body can be moved for adjustment in horizontal axial direction by adjusting two threaded fasteners arranged in axial threaded bores at opposite axial head ends of the anchoring body. In a horizontal direction perpendicular to the axial direction, outer side wall portions of the anchoring body are each provided with two perpendicular threaded holes, each provided with a threaded fastener. These four fasteners engage on opposed outer side faces of the slider body and form a linear guide structure adapted to guide the slider body linearly in the horizontal axial direction relative to the anchoring body. Additional openings in these outer side wall portions of the anchoring body provide access to further threaded fasteners that are mounted in corresponding perpendicular bores in the slider body. These further threaded fasteners engage on the lever members and allow to adjust and fixate the angular position of the pivot pin member that is arranged rotatably about a pivot axis in the slider body.

In use, a pivot anchoring device is subject to significant and repeated forces and impact due to opening and closing of the door, as well as due to the, often very significant, weight of the door.

### OBJECT OF THE PRESENT DISCLOSURE

The known pivot door anchoring devices are not satisfactory in view of their structural robustness. In this regard it is noted that these devices are expected to function reliably for years, in practice without being serviced or the like. Also, adjusting the known pivot door anchoring devices to achieve the correct alignment of the door during installation is cumbersome.

It is an object of the invention to overcome, at least in part, one or more of these drawbacks and/or to provide an improved or alternative pivot door anchoring device.

### SUMMARY

The present invention provides a pivot door anchoring device, which is characterized in that the linear guide structure comprises two parallel elongated protrusions projecting upward on the anchoring body and two parallel elongated recesses in the slider body, the protrusions being confined in the recesses to allow for adjustment motion of the slider body linearly in the axial direction relative to the anchoring body and to prevent motion of the slider body relative to the anchoring body in a horizontal direction perpendicular to the axial direction.

Compared to the mentioned known devices, the axial linear guidance of the slider body relative to the anchoring body is not formed by threaded fasteners. Instead there are parallel elongated protrusions on the anchoring body which are confined in recesses in the slider body. This confinement is such that motion of the slider body relative to the anchoring body in a horizontal direction perpendicular to the axial adjustment direction is prevented. The effect is that most forces, including torsional forces, and impacts to which the pivot door anchoring device is subjected due to opening and/or closing of the door, are absorbed by these elongated protrusions and recesses in cooperation instead of by the multiple perpendicularly arranged threaded fasteners as in the mentioned prior art devices.

In practical embodiments, the slider body has outer side wall portions and outer end wall portions which form exterior faces of the anchoring device. This, e.g., in contrast to the devices disclosed in CN104653009B, where the slider body is located within a central space in the anchoring body, so hidden from view.

In embodiments, the pivot pin member is arranged rotatably about the pivot axis in the slider body in a bearing manner between a first bearing portion and second bearing portion of the slider body. The first and second bearing portions are located between the two elongated protrusions. Each of the bearing portions and the corresponding inner face of the two elongated protrusions form cooperating slide surfaces. Hereby, the bearing parts can directly transfer forces and impacts onto the elongated projections of the anchoring body, e.g. instead of being supported in perpendicular direction via threaded fasteners as in CN104653009B.

In embodiments, each elongated protrusion has an inner face and an outer face, wherein the outer face of each elongated protrusion and inner face of an outer side wall portion of the slider body form cooperating slide surfaces. As will be appreciated this is, preferably, combined with the arrangement discussed in the preceding paragraph, so that an elongated projection is confined in perpendicular horizontal direction between the inner face of an outer side wall portion of the slider body and the outer face of a bearing portion of the slider body. In an embodiment, the outer face of each elongated protrusion defines two axially spaced apart slide surfaces cooperating with the inner face of outer side wall portion of the slider body. In an embodiment, these slide surfaces are located at opposite ends of the elongated protrusion.

In embodiments, each elongated protrusion comprises lobes, e.g. at opposite ends of the elongated protrusion, and an intermediate rib portion connecting the lobes, wherein each lobe defines a slide surface of the protrusion cooperating with the inner face of outer side wall portion of the slider body, and wherein an outer face of the intermediate rib portion is inwardly recessed relative to the slide surfaces defined by the lobes. This arrangement provides for an effective and robust transfer of forces and impacts between the slider body and the protrusion. Also production of this part of the device is more practical than with sliding contact over the entire length of the protrusions.

In practical embodiments, the pivot door anchoring device comprises anchor members projecting from an underside of the anchoring body and configured to be fastened to, e.g. embedded in, the structural element, e.g. the floor.

In an embodiment, each elongated protrusion is provided with axially spaced apart vertical bores each configured for securing an anchor member to the elongated protrusion, e.g. each lobe being provided with a vertical bore, e.g. a threaded bore for a threaded fastener securing the anchor member to the elongated protrusion. This arrangement allows for optimal transfer of forces and impacts from the protrusion to the structural element, e.g. to the floor. It, for example, allows for a bottom plate portion of the anchoring body to be rather thin, e.g. allowing for limited total height of the anchoring device.

In practical embodiments, the pivot pin angle adjustment assembly comprises two lever members extending radially outwardly in opposite directions from the pivot pin member.

In embodiments, an outer side wall portion of the slider body is provided with at least one threaded bore extending perpendicular to the axial direction, wherein the lever adjustment member is a threaded fastener in the perpendicular bore, which fastener is accessible from the outside and is in engagement with a lever member. For example, two axially spaced apart threaded bores with a threaded fastener therein are present, each fastener in engagement with a respective one of the two lever members. This provides easy access to the lever adjustment for the person installing the device and the pivot door.

In embodiments, the anchoring body is provided with an upward projecting portion which is provided with a threaded axial bore extending in the axial direction, wherein the linear adjustment member is a threaded fastener in the threaded axial bore, wherein the threaded fastener is arranged between opposed axial faces of the slider body, and wherein the threaded fastener is accessible from an axial outer side of the slider body, allowing to move the slider body in opposite axial directions relative to the anchoring body. In a practical embodiment, the upward projecting portion is integral with an axial end of an elongated protrusion, e.g. adjoining a lobe of the elongated protrusion. In this design only a single threaded fastener needs to be operated to cause the desired linear movement of the slider body relative to the anchoring body. This is convenient for a person installing the device and the pivot door.

In practical embodiments, the slider body, the anchoring body, and the pivot pin member with lever(s), are made of a metal, e.g. steel, e.g. stainless steel.

In an embodiment, one of the slider body and the anchoring body is provided with a magnet configured to keep these components together, e.g. when taking them out of a packaging.

The pivot door anchoring device may be provided with a marking and/or markings on the slider body and/or anchoring body to give a sensory cue, e.g. a visual cue, for an installer as to the relative lateral position of the slider body with respect to the anchoring body.

The pivot door anchoring device may be provided with a marking and/or markings on the slider body and/or pivot pin angle adjustment assembly to give a sensory cue, e.g. a visual cue, for an installer as to the relative angular position of the pivot pin angle adjustment assembly with respect to the slider body.

A second aspect of the present invention relates to a pivot door anchoring device for pivotally connecting a pivot hinge member for a pivot door with a structural element, wherein the pivot door anchoring device comprises:
an anchoring body configured to be mounted to the structural element, e.g. to a floor, for anchoring the pivot door anchoring device to the structural element,
a slider body mounted movably relative to the anchoring body,
a linear adjustment assembly adapted to move the slider body linearly between an inward position and an outward position, the linear adjustment assembly having a linear guide structure and a linear adjustment member,
wherein the linear adjustment member is in engagement with the anchoring body and is in engagement with the slider body such that operating the linear adjustment member causes the slider body to move between the inward and outward positions relative to the anchoring body,
a pivot pin angle adjustment assembly having a lever member and a lever adjustment member cooperating with the lever member,
wherein the pivot pin angle adjustment assembly has a pivot pin receiving member connected to the lever member, the pivot pin receiving member having an opening for a pivot pin member of a pivot hinge member, or wherein the pivot pin angle adjustment assembly has a pivot pin member connected to the lever member,
wherein the pivot pin member or the pivot pin receiving member are arranged rotatably about a pivot axis in the slider body, and wherein the lever adjustment member is in engagement with the lever member and is in engagement with the slider body such that operating the lever adjustment member causes the lever member to rotate about the pivot axis, which causes rotation of the pivot pin member or the pivot pin receiving member about the pivot axis.

The device of the second aspect may be provided with one or more features discussed herein, e.g. with reference to the device of claim 1, e.g. with one or more features according to one or more of the (sub-)claims.

In an embodiment of the second aspect, the linear guide structure comprises a cooperating recess and protrusion, one of the recess and protrusion being arranged in or on the anchoring body and the other being arranged in or on the slider body, wherein the recess is configured such that linear movement between the inward and outward positions of the cooperating protrusion in the recess is along a length of the recess. In an embodiment, the linear guide structure comprises a further cooperating recess and protrusion, one of the further recess and protrusion being arranged in or on the anchoring body and the other being arranged in or on the slider body, wherein the further recess is with a length thereof oriented parallel to the other recess. In an embodiment, the protrusions are confined in the cooperating recess in a direction perpendicular to the linear movement between the inward and outward positions such that substantial movement in this perpendicular direction is prevented.

In an embodiment of the second aspect, the pivot pin angle adjustment assembly comprises two lever members, each lever member associated with a corresponding lever adjustment member, e.g. the two lever members extending radially outwardly in opposite directions from the pivot pin member or the pivot pin receiving member.

In an embodiment of the second aspect, the anchoring body and slider body cooperate to form a casing of the pivot door anchoring device, wherein the linear adjustment member and/or lever adjustment member, or lever adjustment members, is or are operable from an outer side of the casing, e.g. at one or more sides thereof.

The present invention also relates to a method of adjusting a pivot door anchoring device as described herein, wherein the method comprises the steps of:
operating the linear adjustment member, preferably just one linear adjustment member, to adjust an axial position of the slider body relative to the anchoring body, and/or
operating the lever adjustment member to adjust an angle of the pivot pin member relative to the slider body.

The invention will be explained further with reference to the drawings, in which like reference symbols designate like parts.

### BRIEF DESCRIPTION OF THE DRAWINGS

In these drawings:

FIG. 1 schematically shows an exploded view in perspective of a pivot door anchoring device according to the invention,

FIG. 2 schematically shows a further exploded view in perspective of the pivot door anchoring device of FIG. 1,

FIG. 3A schematically shows a view in perspective of the pivot door anchoring device of FIGS. 1A-1B in an assembled state,

FIG. 3B schematically shows a cross-section of the pivot door anchoring device along A-A

shown in FIG. 3A, FIGS. 4A-4C schematically show a top view of a cross-section of the pivot door anchoring device of FIGS. 1A-1C , wherein the linear adjustment assembly is in an outward state, a neutral state, and an inward state, respectively,

FIGS. 5A-5C schematically show a top view of a cross-section of the pivot door anchoring device of FIGS. 1A-1C , wherein the pivot pin angle adjustment assembly is in a neutral state, a first rotated state and a second rotated state, respectively,

FIGS. 6A-6C schematically show a bottom view of the pivot door anchoring device of FIGS. 1A-1C, wherein the linear adjustment assembly is in the outward state, the neutral state, and the inward state, respectively,

FIGS. 7A-7C schematically show a top view of the pivot door anchoring device of FIG. 1A 1C, wherein the pivot pin angle adjustment assembly is in the first rotated state, the neutral state and the second rotated state, respectively,

FIG. 8 schematically shows a view in perspective of a pivot door hinge system according to the invention,

FIG. 9A schematically shows a view in perspective of a cross section of another embodiment of a pivot door anchoring device,

FIG. 9B schematically shows a detail of the pivot door anchoring device of FIG. 9A.

### DETAILED DESCRIPTION OF EMBODIMENTS

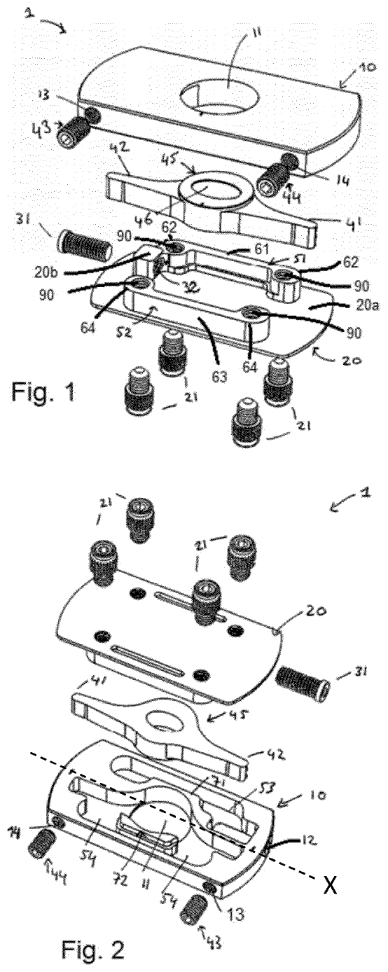

With reference to the FIGS. 1-7C a first exemplary embodiment will be discussed of a pivot door anchoring device 1 for pivotally connecting a pivot hinge member that is secured to a pivot door with a structural element, for example to the floor of a building.

The device 1 comprises:
an anchoring body 20 which configured to be mounted to the structural element, e.g. to a floor, for anchoring the pivot door anchoring device 1 to the structural element,
a slider body 10 mounted movably relative to the anchoring body 20,
a linear guide structure adapted to guide the slider body linearly in one horizontal axial direction, denoted with X, relative to the anchoring body 20,
a linear adjustment member 31 in engagement with the anchoring body 20 and with the slider body 10 such that operating the linear adjustment member 31 causes the slider body to move linearly in the axial direction X relative to the anchoring body 20.

The device 1 further comprises a pivot pin angle adjustment assembly with:
a pivot pin member 45 which is arranged rotatably about a pivot axis P in the slider body 10, which pivot pin member has an opening 46 for a pivot pin of a pivot hinge member of a pivot door,
two lever members 41, 42 connected to the pivot pin member 45 and extending in the axial direction in opposite directions away from the pivot pin member 45,
two lever adjustment member 43, 44, each in engagement with a corresponding lever member 41, 42 and with the slider body 10 such that operating the lever adjustment members 43, 44 causes the lever members 41, 42 and the pivot pin member 45 to rotate about the pivot axis P.

The two lever members 41, 42 extend radially outwardly in opposite directions along the X direction from the pivot pin member 45.

The device 1 may be seen to comprise a linear adjustment assembly adapted to move the slider body 10 linearly in an axial direction between an inward position (e.g. shown in FIG. 4C) and outward position (e.g. shown in FIG. 4A), the linear adjustment assembly having the linear guide structure and the linear adjustment member 31.

The linear adjustment member 31 is in engagement with the anchoring body 20 and is in engagement with the slider body 10 such that operating the linear adjustment member 31 causes the slider body 10 to move between the inward and outward positions relative to the anchoring body 20.

The anchoring body 20 has a bottom plate portion 20a which is configured to the placed against the floor or other structural element. The bottom plate portion 20a has a thickness of a few millimetres, preferably, to keep the total height of the device 1 limited.

The linear guide structure comprises two parallel elongated protrusions 51, 52 projecting upward on the anchoring body 20, here upward from the bottom plate portion 20a, and two parallel elongated recesses 53,54 in the slider body 10. The protrusions 51, 52 protrude from below into the recesses 53, 54 in the slider body.

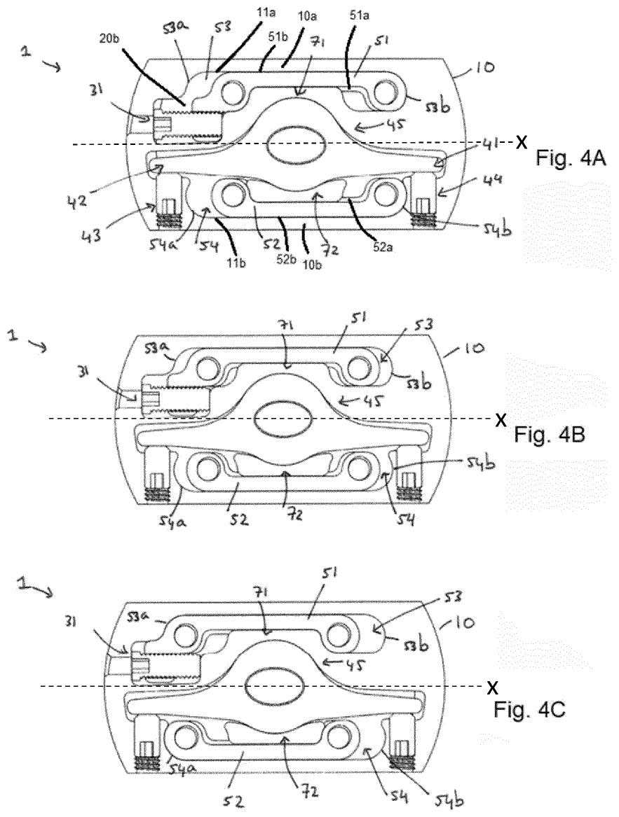

It can be seen in FIG. 3A that the anchoring body 20 and slider body 10 cooperate to form a casing of the pivot door anchoring device 1.

The protrusions 51, 52 are confined in the recesses 53, 54 to allow for motion of the slider body 10 linearly only in the axial direction X relative to the anchoring body 20 and to prevent motion of the slider body 10 relative to the anchoring body 20 in a horizontal direction perpendicular to the axial direction X.

The slider body 10 has outer side wall portions 10a, 10b forming opposed outer sides of the slider body, the sides extending generally in X-direction.

The linear adjustment member 31 and the lever adjustment members 43, 44 are operable from an outer side of the slider body 10, here at an axial end and at a longitudinal side thereof.

As shown, one outer side wall portion 10b is provided with two threaded bores 13, 14 extending perpendicular to the axial direction X. In each bore 13, 14 a corresponding lever adjustment member 43, 44, here embodied as a threaded fastener, is mounted in the bore.

Each fastener 43, 44 is accessible from the outside of the device 1, and is in engagement with a respective one of the two lever members.

As shown, the pivot pin member 45 is arranged rotatably about the pivot axis P in the slider body 10 in a bearing manner between a first bearing portion 71 and second bearing portion 72 of the slider body. The first and second bearing portions 71, 72 are located between the two elongated protrusions 51, 52.

As preferred, each of the bearing portions 71, 72 and the corresponding inner face of the two elongated protrusions 51, 52 form cooperating slide surfaces in the axial direction X.

The pivot pin receiving member 45 and the bearing portions 71, 72 are arranged between the cooperating recesses and protrusions 51, 53 and 52, 54. This allows for a compact design of the pivot door anchoring device 1.

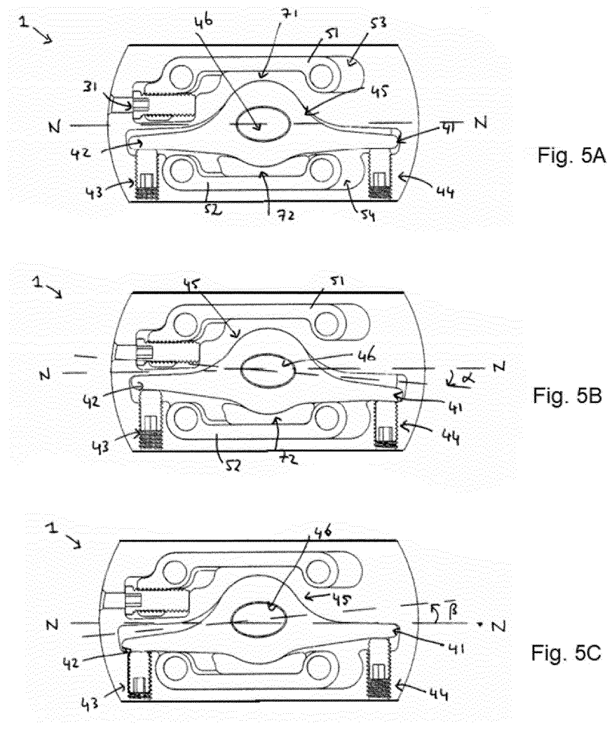

The pivot pin receiving member 45 is arranged rotatably about a pivot axis P (e.g. shown in FIG. 3A) in the slider body 10. The lever adjustment members 43, 44 are in engagement with the lever members 41,42 and are in engagement with the slider body 10 such that operating the lever adjustment members 43, 44 causes the lever members 41, 42 to rotate about the pivot axis P, which causes rotation of the pivot pin receiving member 45 about the pivot axis P. Such rotations caused by operating the lever adjustment members 43 44 are e.g. shown in FIGS. 5B and 5C.

In FIGS. 5A-5C is shown a top view of a cross-section of the pivot door anchoring device 1, wherein the pivot pin angle adjustment assembly is in a neutral state, a first rotated state and a second rotated state, respectively. In the first rotated state, the pivot pin receiving member 45 is rotated by an angle a relative to the neutral line N-N that designates the neutral state in FIG. 5A. In the second rotated state, the pivot pin receiving member 45 is rotated by an angle ß relative to the neutral line N-N.

Operating the lever adjustment members 43, 44 allows to adjust an angle of a pivot pin member 45 relative to the slider body 10.

Each elongated protrusion 51, 52 has an inner face 51a, 52a, facing the other protrusion, and an outer face 51b, 52b. The outer face 51b, 52b of each elongated protrusion 51, 52 and the adjacent inner face 11a, 11b of an outer side wall portion 10a, 10b of the slider body form cooperating slide surfaces.

The anchor members 21 project from the underside of the anchoring body 20 and are configured to be fastened to, e.g. embedded in, the structural element, e.g. the floor.

Each elongated protrusion 51, 52 is provided with axially spaced apart vertical bores 90, each bore 90 configured for securing an anchor member 21 to the elongated protrusion.

For example, as shown, each bore 90 in a protrusion 51, 52 is a threaded bore for a threaded fastener, e.g. a screw or bolt, securing the anchor member 21 to the elongated protrusion 51, 52.

In more detail, each of the elongated protrusions 51, 52, comprises lobes 62, 64 at opposite ends of the elongated protrusion and an intermediate rib portion 61, 63 connecting the lobes. The bores 90 are provided in the lobes 62, 64.

The anchoring body 20 is provided with an upward projecting portion 20b which is provided with a threaded axial bore 32 extending in the axial direction X. The linear adjustment member is a threaded fastener 31 in the threaded axial bore 32.

The threaded fastener 31 is arranged to fit between opposed axial faces 12a, 12b of the slider body 10. Head end engages on face 12a and shaft end 31c engages on face 12b. The head end of fastener 31 is accessible from an axial outer side 10c of the slider body via axial bore 12 by a tool to rotate the fastener. This allows to move the slider body 10 in opposite axial directions relative to the anchoring body 20 by rotating the one fastener 31. Moving the slider body 10 towards the inward position is done by screwing the fastener 31 with thread 31b out of thread 32 of the anchoring body 20. A screw motion of the fastener 31 in opposite direction, urges the end face 31c against the slider body 10 so that it moves towards the outward position.

In FIGS. 4A-4C is shown a top view of a cross-section of the pivot door anchoring device 1, wherein the linear adjustment assembly is in the outward position, a neutral position, and the inward position, respectively.

In the inward position shown in FIG. 4C the protrusion 51 abuts with one end an inward edge 53a of the recess 53. In the outward position shown in FIG. 4A the protrusion 51 abuts with another end an outward edge 53b of the recess 53.

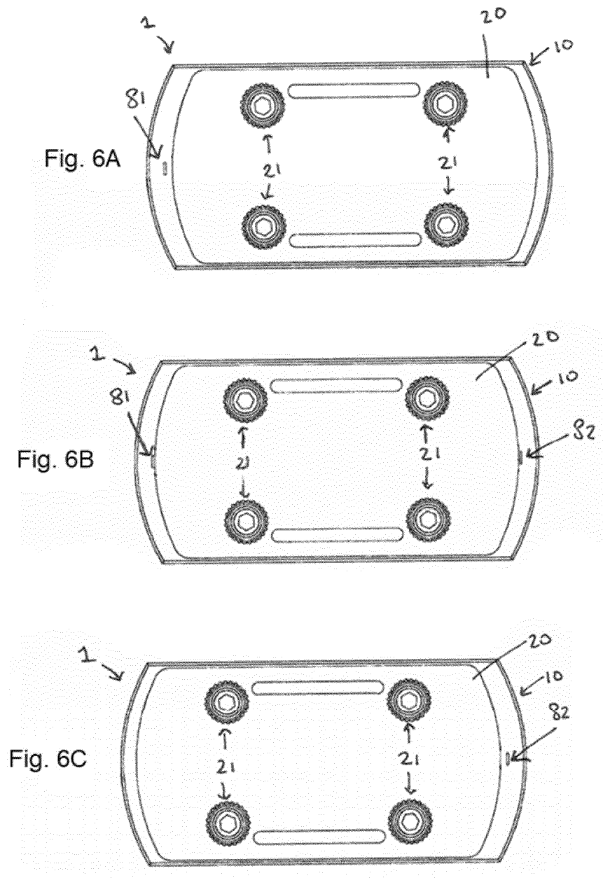

It can be seen in FIGS. 6A-6C that the pivot door anchoring device 1 is provided with markings 81, 82 on the slider body to give a sensory cue, e.g. a visual cue, for a person installing the device 1 and/or the door as to the relative lateral position of the slider body 10 with respect to the anchoring body 20.

In the neutral state shown in FIG. 6B the markings 81, 82 on the slider body 10 are positioned on either side of the anchoring body 20. Therefore these are e.g. visible and/or tactile for an installer.

In the outward state shown in FIG. 6A only marking 81 is positioned on a side of the anchoring body 20, as the slider body 10 has moved laterally such that it is positioned on top of marking 82.

In the inward state shown in FIG. 6A only marking 82 is positioned on a side of the anchoring body 20, as the slider body 10 has moved laterally such that it is positioned on top of marking 81.

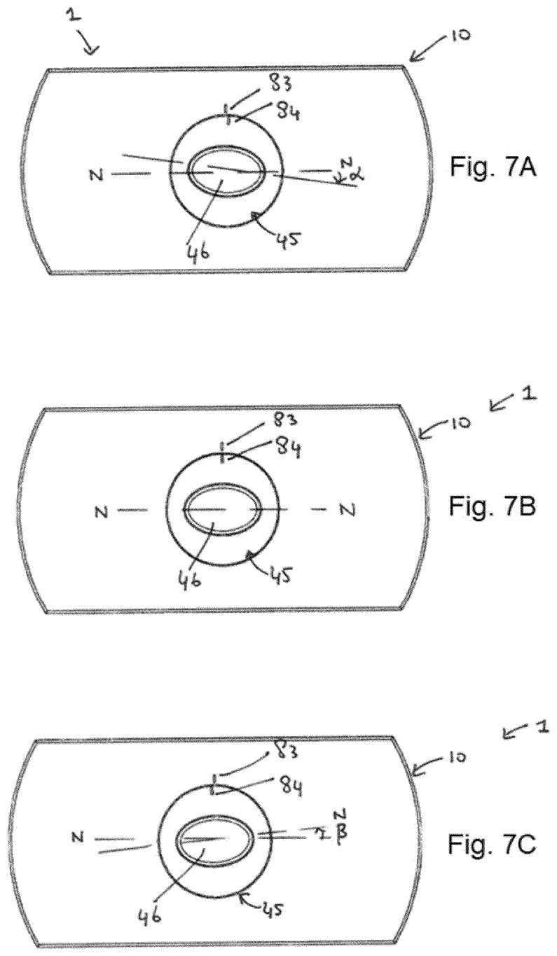

It can be seen in FIGS. 7A-7C that the pivot door anchoring device 1 is provided with markings 83, 84 on the slider body 10 and on the pivot pin angle adjustment assembly to give a sensory cue, e.g. a visual cue, for a person installing the device 1 and/or the door as to the relative angular position of the pivot pin angle adjustment assembly with respect to the slider body 10.

In the neutral state of FIG. 7B the markings 83, 84 are in alignment. In the first rotated state (FIG. 7A) and the second rotated state (FIG. 7C) the markings 83, 84 are out of alignment, with marking 84 being rotated towards the right, and towards the left of marking 83, respectively.

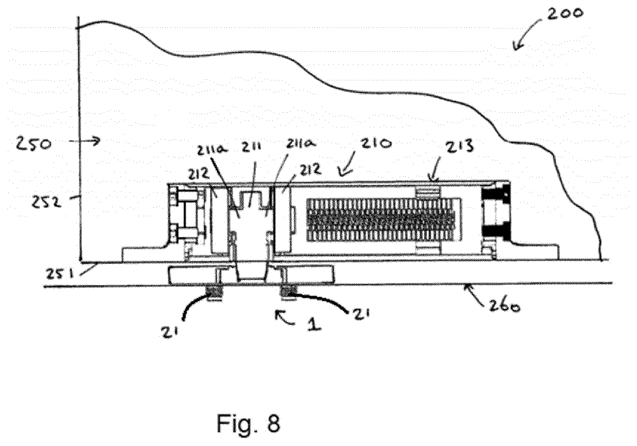

As shown, schematically, in FIG. 8 a pivot door hinge system comprising a pivot door anchoring device 1 and a pivot hinge member 210 secured to a pivot door 250.

The door 250 has an upper edge, a lower edge 251, an inner side edge 252 (e.g. facing a wall of a building), and an outer side edge. Here, the pivot hinge member is mounted to the lower edge 252 of the pivot door. The pivot door anchoring device 1 is mounted to a structural element, here floor 260.

The pivot hinge member 210 comprises a downwardly projecting pivot pin 211, which pivot pin is received in the opening 46 of the pivot pin member 45 of the pivot door anchoring device 1. The pivot pin 211 is non-rotatably secured in the pivot pin member, here as their mating cross-sections are non-circular, here oval. Other securing arrangements, e.g. using a cross-section, e.g. a splined connection, are also possible.

The Pivot hinge member 210 comprises a casing, here mounted to the pivot door 250.

The pivot hinge member 210, in this example, further comprises a spring arrangement 213 that is adapted to urge a cam follower 212 against a cam 211a of the pivot pin member 211 so as to define one or more stable positions of the door 250 and/or to provide a biasing of the door towards one or more stable positions, e.g. to a closed position.

Operating the linear adjustment member 31 of pivot door anchoring device 1 allows to adjust a lateral position of the slider body 10 relative to the anchoring body 20 so as to adjust a lateral position of the pivot pin member 211 relative to the anchoring body 20, so here to the floor 260.

Operating the lever adjustment member 43, 44 of pivot door anchoring device 1 allows to adjust an angle of the pivot pin member 211 relative to the slider body 10 so as to adjust an angle of the pivot pin member 211 relative to the slider body 10.

In use, when installing the device 1 and the door 250, adjustment of the device 1, can be done with a method comprising the steps of:
operating the one linear adjustment member 31 to adjust the axial position of the slider body 10 relative to the anchoring body 20, and/or
operating the two lever adjustment members 43, 44 to adjust the angle of the pivot pin member 45 relative to the slider body 10.

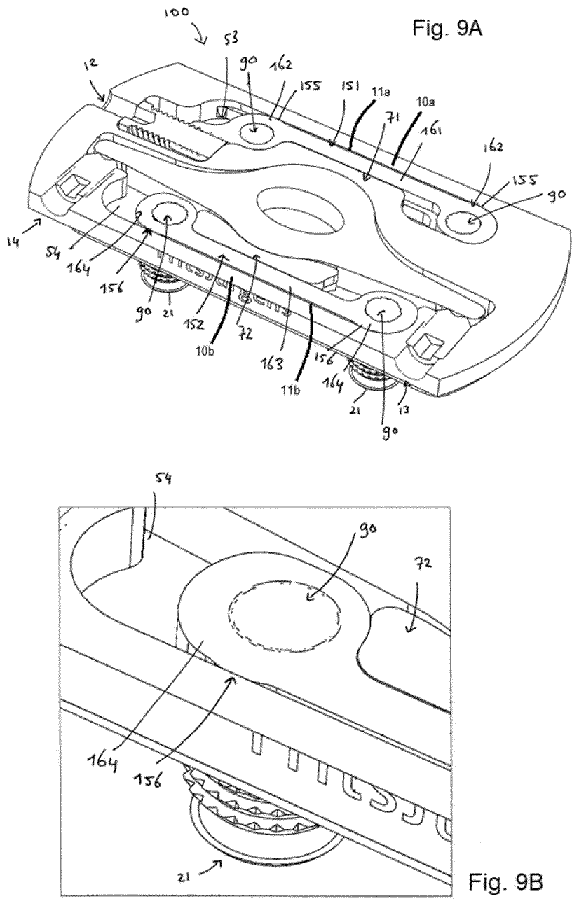

In FIGS. 9A and 9B is shown a pivot door anchoring device 100 for pivotally connecting a pivot hinge member for a pivot door with a structural element. The pivot door anchoring device 100 differs from the pivot door anchoring device 1 in particular with regards to the detailed design of the elongated protrusions 151, 152.

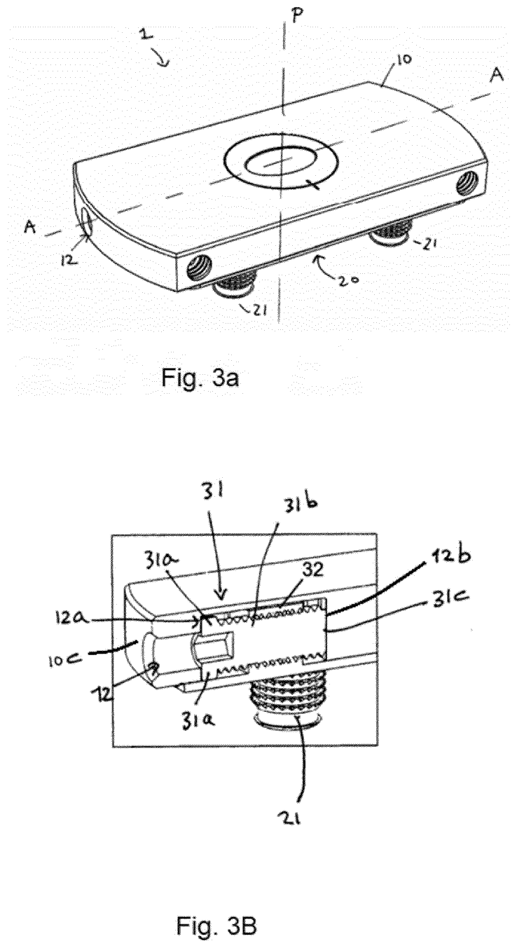

The linear guide structure of pivot door anchoring device 100 comprises two parallel elongated protrusions 151, 152 projecting upward on the anchoring body 20 and two parallel elongated recesses in the slider body 10 in which the protrusions are received. The protrusions 151, 152 are confined in the recesses 53, 54 to allow for motion of the slider body 10 only linearly in the axial direction, i.e. in the direction of axis X (e.g. shown in FIG. 2), relative to the anchoring body 20 and to prevent motion of the slider body 10 relative to the anchoring body 20 in a horizontal direction perpendicular to the axial direction.

Each elongated protrusion 151, 152 comprises lobes 162, 164 at opposite ends of the elongated protrusion and an intermediate rib portion 161, 163 connecting the lobes.

As shown in FIGS. 9A, 9B, the outer face of each elongated protrusion 151, 152 defines two axially spaced apart slide surfaces 155, 156, here at ends of the elongated protrusion, here each part of the respective lobe 162, 164. An outer face of the intermediate rib portion 161, 163 is inwardly recessed relative to the pair of slide surfaces defined by the lobes 162, 164.

Each pair of slide surfaces 155, 156 of an elongated protrusion 151, 152 cooperates with the adjacent inner face 11a, 11b of the outer side wall portion 10a, 10b of the slider body.

As in the other embodiment discussed above, each elongated protrusion is provided with axially spaced apart vertical bores 90 for securing anchor members 21 to the elongated protrusion, e.g. each lobe being provided with a vertical bore 90, e.g. a threaded bore for a threaded fastener securing the anchor member to the elongated protrusion.

What is claimed is:

1. A pivot door anchoring device for pivotally connecting a pivot hinge member for a pivot door with a structural element, wherein the pivot door anchoring device comprises:
an anchoring body configured to be mounted to the structural element for anchoring the pivot door anchoring device to the structural element,
a slider body mounted movably relative to the anchoring body,
a linear guide structure adapted to guide the slider body linearly in a horizontal axial direction relative to the anchoring body,
a linear adjustment member in engagement with the anchoring body and with the slider body such that operating the linear adjustment member causes the slider body to move linearly in the axial direction relative to the anchoring body,
a pivot pin angle adjustment assembly comprising:
a pivot pin member which is arranged rotatably about a pivot axis in the slider body wherein the pivot pin member has an opening for a pivot pin of a pivot hinge member of a door or wherein the pivot pin member has a pivot pin connectable with a pivot hinge member of a door,
a lever member connected to the pivot pin member and extending in the axial direction,
a lever adjustment member in engagement with the lever member and with the slider body such that operating the lever adjustment member causes the lever member and the pivot pin member to rotate about the pivot axis,
wherein the linear guide structure comprises two parallel elongated protrusions projecting upward on the anchoring body and two parallel elongated recesses in the slider body, the elongated protrusions being confined in the elongated recesses to allow for adjustment motion of the slider body linearly in the axial direction relative to the anchoring body and to prevent motion of the slider body relative to the anchoring body in a horizontal direction perpendicular to the axial direction.

2. The pivot door anchoring device according to claim 1, wherein the pivot pin member is arranged rotatably about the pivot axis in the slider body in a bearing manner between a first bearing portion and second bearing portion of the slider body, and wherein the first and second bearing portions are located between the two elongated protrusions, wherein each of the bearing portions and the corresponding inner face of the two elongated protrusions form cooperating slide surfaces.

3. The pivot door anchoring device according to claim 1, wherein each elongated protrusion has an inner face and an outer face wherein the outer face of each elongated protrusion and inner face e of an outer side wall portion of the slider body form cooperating slide surfaces

4. The pivot door anchoring device according to claim 3, wherein the outer face of each elongated protrusion defines two axially spaced apart slide surfaces cooperating with the inner face of the outer side wall portion of the slider body.

5. The pivot door anchoring device according to claim 1, wherein each elongated protrusion comprises lobes at opposite ends of the elongated protrusion and an intermediate rib portion connecting the lobes, wherein each lobe defines a slide surface of the elongated protrusion cooperating with an inner face of the outer side wall portion of the slider body.

6. The pivot door anchoring device according to claim 5, wherein an outer face of the intermediate rib portion is inwardly recessed relative to the slide surfaces defined by the lobes.

7. The pivot door anchoring device according to claim 1, wherein the pivot door anchoring device comprises anchor members projecting from an underside of the anchoring body and configured to be fastened to, the structural element,

8. The pivot door anchoring device according to claim 7, wherein each elongated protrusion is provided with axially spaced apart vertical threaded bores, which vertical threaded bores are each configured for securing an anchor member to the elongated protrusion by a threaded fastener.

9. The pivot door anchoring device according to claim 1, wherein the pivot pin angle adjustment assembly comprises two lever members extending radially outwardly in opposite directions from the pivot pin member.

10. The pivot door anchoring device according to claim 1, wherein an outer side wall portion of the slider body is provided with two axially spaced apart threaded bores each extending perpendicular to the axial direction, and wherein the lever adjustment member is a threaded fastener in said threaded bore, which fastener is accessible from outside and is in engagement with a respective one of the two lever members.

11. The pivot door anchoring device according to claim 1, wherein the anchoring body is provided with an upward projecting portion which is provided with a threaded axial bore extending in the axial direction, wherein the linear adjustment member is a threaded fastener in the threaded axial bore, wherein the threaded fastener is arranged between opposed axial faces of the slider body, and wherein the threaded fastener is accessible from an axial outer side of the slider body, allowing to move the slider body in opposite axial directions relative to the anchoring body.

12. The pivot door hinge system comprising a pivot door anchoring device according to claim 1, and a pivot hinge member,
wherein the pivot hinge member comprises a pivot pin which pivot pin is received in, or to be received in, an opening of the pivot pin member of the pivot door anchoring device or
wherein the pivot hinge member is configured to receive a pivot pin of the pivot pin member of the pivot door anchoring device.

13. The pivot door hinge system according to claim 12, further comprising a pivot door, and wherein the pivot hinge member is mounted to the pivot door the pivot door having an upper edge, a lower edge an inner side edge and an outer side edge, wherein the pivot hinge member is mounted to the lower edge of the pivot door, wherein the pivot door anchoring device is mounted to the a structural element.

14. The pivot door hinge system according to claim 12, wherein the pivot hinge member and the pivot door anchoring device are configured such that the pivot door has a stable closed position relative to the structural element, and is rotatable around the vertical pivot axis in two directions relative to the stable closed position.

15. (canceled)

16. The pivot door anchoring device according to claim 4, wherein the slide surfaces are at opposite ends of the elongated protrusion.

17. The pivot door anchoring device according claim 7, wherein the pivot door anchoring device comprises anchor members projecting from an underside of the anchoring body and configured to be embedded in the structural element.

18. The pivot door anchoring device according to claim 17, wherein each elongated protrusion is provided with axially spaced apart vertical threaded bores, which vertical threaded bores are each configured for securing an anchor member to the elongated protrusion by a threaded fastener.
